(19) United States
(12) Patent Application Publication
(10) Pub. No.: US 2004/0080429 A1
(43) Pub. Date: Apr. 29, 2004

(54) Poly-operative remote sensing system and method

(75) Inventor: James D. Wolfe, Colleyville, TX (US)

Correspondence Address: BAKER BOTTS L.L.P., 2001 ROSS AVENUE, SUITE 600, DALLAS, TX, 75201-2980, US

(73) Assignee: Lockheed Martin Corporation

(21) Appl. No.: 10/232,988

(22) Filed: Aug. 28, 2002

(51) Int. Cl. G08C 19/00; H04Q 9/00; G08C 19/10

(52) U.S. Cl. 340/870.07; 340/870.11

(57) ABSTRACT

A method for remote sensing includes receiving, at a first module of an array of modules, incident electromagnetic energy from an external source. The incident electromagnetic energy is converted to a source of power for the first module. A value is measured, at the first module, of at least one environmental parameter adjacent the first module. A signal is encoded with the value of the at least one environmental parameter. The signal is transmitted to a central processing subsystem independently of transmissions from other ones of the array of modules.

### TECHNICAL FIELD OF THE INVENTION

The invention relates generally to remote sensing systems and, more particularly, to a poly-operative remote sensing system and method.

### BACKGROUND OF THE INVENTION

In many industries, sensors are used during testing and operation of mechanical systems, machines, parts and components, to test, evaluate and/or predict performance characteristics, and analyze conditions just prior to, and during system failure. Such sensors are used to monitor one or more environmental characteristics (e.g. temperature, stress, pressure, electric potential, strain, proximity, moisture, and other environmental parameters) encountered by the system. Typically, dozens, hundreds, and even thousands of sensors will be used in a sensing system, to analyze a single system. Each sensor must be coupled for communication with instrumentation (e.g., processors) and requires a power source.

The number, size, placement, and cost of the sensors depend upon, among other things, the type of module, power source, and instrumentation used to collect, calculate, manipulate and report the data collected. Sensors which utilize battery power and include their own associated instrumentation tend to be bulky, and expensive. Other systems use sensors that communicate data to a central data collection system, which may be located remote from the sensor. For example, a remote sensing system may employ an interleaving technique to transmit signals to the data collection system. This configuration limits the transmitting time of each module and requires a higher clock rate as the number of sensors increase.

### SUMMARY OF THE INVENTION

According to the present invention, problems and disadvantages associated with previous methods and systems for remotely monitoring and processing data of environmental characteristics may be reduced or eliminated. In accordance with a particular embodiment of the present invention, each sensor includes a power accumulator that receives electromagnetic energy from an external source, and converts the energy to a source of power for the sensor. The sensor also transmits collected data, independently of adjacent sensors, to a central processing subsystem. Because each sensor operates independently and does not need to be time-multiplexed with other sensors, the internal clocking rates can be reduced which results in reduced size, cost and complexity for each sensor. Furthermore, the independent transmission scheme allows each sensor to transmit the same number of data samples as a multiplexed system while using less total power.

According to one aspect of the present invention, a method for remote sensing includes receiving, at any module of an array of modules, incident electromagnetic energy from an external source. The module converts the incident electromagnetic energy to a source of power for the module. A value of at least one environmental parameter is measured adjacent to the module. A signal is encoded with the value of the measured parameter. Also, the signal is encoded with a unique identification associated with that module. The remote module transmits the signal to a central processing subsystem independently of transmissions from other members of the array of modules.

In accordance with another aspect of the present invention, the central processing subsystem receives a plurality of signals from the array of modules, where each of the signals is associated with a respective member of the modules. The central processing subsystem decodes the plurality of signals and associates each signal of the plurality of signals with the respective module based on the unique identification associated with the respective module. Upon associating each signal of the plurality of signals with the respective module, the central processing subsystem performs additional algorithms to format and analyze data collected by the plurality of sensors.

Technical advantages of particular embodiments of the present invention include a remote sensor that derives power from incident electromagnetic energy. Therefore, a local power source is not required which reduces the overall size and weight of the sensor, and allows more sensors per unit area (or volume). A physical connecting harness is not required to provide control signals, data transmission, and power, which greatly enhances the flexibility of remote sensor placement, reduces manufacturing costs, and simplifies installation. Additionally, the absence of battery packs reduces the weight and size of the remote module packages, decreasing the distortion in measured data and enhancing the resolution in the measured data.

Another technical advantage of particular embodiments of the present invention includes a sensor which accommodates independent, simultaneous transmission of data from a system of remote modules. This increases the allowable sampling rate without commensurate increases in the internal module operational rates, even when thousands of modules are include in the system for remote sensing.

Still another technical advantage of particular embodiments of the present invention includes a remote sensing system that utilizes an encoding and decoding scheme that accommodates independent transmissions from multiple modules and simultaneous reception of multiple signals by the central processing subsystem. The central processing subsystem is able to collect, decode, manipulate, record, store and/or report the data collected from multiple signals received from multiple sensors, regardless of the order, sampling rate or time at which any particular module transmits data.

Other technical advantages of the present invention will be readily available to one skilled in the art from the following figures, descriptions, and claims.

### BRIEF DESCRIPTION OF THE DRAWINGS

For a more complete understanding of the present invention and its advantages, reference is now made to the following description, taken in conjunction with the accompanying drawings, in which:

FIG. 1 illustrates an instrumentation system using remote sensing modules and a central processing subsystem, in accordance with a particular embodiment of the present invention;

FIG. 2 illustrates a block diagram of a remote sensing module of FIG. 1;

FIG. 3 illustrates a block diagram of the central processing subsystem of FIG. 1; and

FIG. 4 illustrates a method for remote sensing, in accordance with a particular embodiment of the present invention.

### DETAILED DESCRIPTION OF THE INVENTION

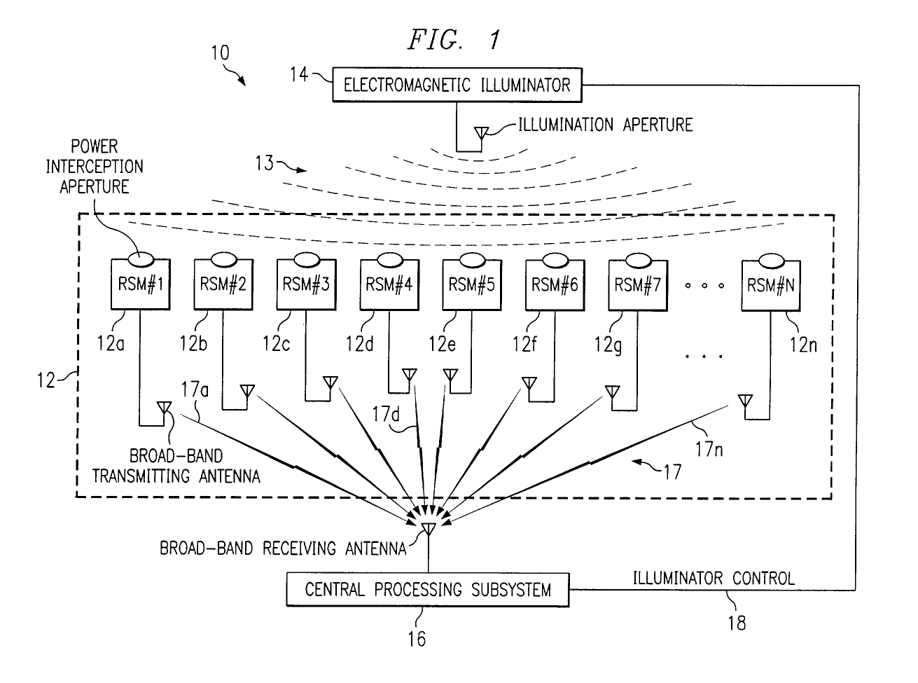

FIG. 1 illustrates a self-powered system 10 for remote sensing capable of simultaneous, non-interfering operation from remote locations while providing independent sensor readout by wireless communication to a central processing subsystem. System 10 includes a plurality of remote sensing modules 12, wherein each module is self-powered and has the ability to transmit measured data associated with the respective module to a central processing subsystem 16.

In the embodiment illustrated in FIG. 1, each remote sensing module 12 comprises a poly-operative, low-powered remote sensing module. However, other remote sensing modules are contemplated within the teachings of the present invention. Each of the remote modules 12a-12n (hereinafter individually and/or collectively referred to as remote sensing module(s) 12) of FIG. 1 is operable to receive incident electromagnetic energy 13 (e.g., RF, IR, UV, visible light) from an external source 14, and convert the incident electromagnetic energy 13 to a source of power for the respective module 12. The absence of a physical link for a source of power enhances the flexibility of remote sensor placement, reduces manufacturing costs, and simplifies installation. Additionally, the absence of a battery pack enhances the resolution of measured data because the number of remote modules per area or volume increase as the module 12 decreases in size.

Upon converting the incident electromagnetic energy 13 to a source of power, each of the plurality of modules 12 is operable to measure a value of at least one environmental parameter adjacent the respective module. A signal is encoded with the value of the at least environmental parameter. Also, the respective module is capable of encoding the respective signal with a unique identification associated with the respective module. After which, the respective module is operable to transmit the respective signal 17 to a central processing subsystem 16.

In accordance with a particular embodiment of the present invention, output signal are spread-spectrum signals. Spread spectrum signals are characteristic of data encoded in orthogonal-set encoding algorithms such as gold codes. Gold codes allow simultaneous transmission by hundreds or thousands of sensors with no problem for the broadband receiver simultaneously collecting the information from all transmitters. The gold codes (a different code for each chip) can be decoded with digital convolution filters to extract the data sent individually by each sensor. An example of a gold code in action is the ubiquitous GPS system in use today.

Using the gold code filters to extract the individual sensor data (e.g., micro-electromechanical systems or MEMS chips) simplifies the size, complexity, and power source of individual MEMS chips, by transferring complexity to a single computer (central processing subsystem) that processes the spread spectrum receiver output.

Central processing subsystem 16 is capable of decoding a plurality of signals 17 from the plurality of modules 12. Upon receiving at least one signal, for example signal 17a, from the plurality of remote modules 12, central processing system 16 is operable to decode the at least one signal 17a from the plurality of remote modules 12. Encoding may include associating the value of the at least one environmental parameter with the respective module based on the unique identification associated with the respective module. Therefore, the encoding and decoding scheme enables unique identification of each module and association of a particular module with the respective signals. Additionally, centralizing the decoding scheme to one central processing subsystem 16 for all remote modules 12 substantially reduces the cost of system 10.

In accordance with a particular embodiment of the present invention, central processing subsystem 16 provides feedback 18 to the external source 14, based on information associated with the decoded signal. Also, central processing system 16 may be operable to display and record any data decoded from the at least one signal. Although in the illustrated embodiment central processing subsystem 16 is represented as a single central processing subsystem, the invention is not so limited and may include any combination or a plurality of such processing subsystems.

External source 14 of electromagnetic energy 13 may include a controlled source of electromagnetic energy, which will be referred to as an electromagnetic illuminator. For example, an electromagnetic illuminator may comprise (1) a narrow-spectrum radio frequency transmitter and tuned antenna that provides a high power spectrum density that can be intercepted by remote sensing module 12 and converted to electrical power suitable for operating a low voltage integrated circuit associated with module 12; (2) a high intensity, unfocused light source that operates at wavelengths suitable for conversion to similar types of electrical power by photo detector devices; (3) a coherent light source with narrow beams directed toward each of the modules, and operating at wavelengths suitable for conversion to electrical power by photo detector devices; (4) high frequency magnetic field generators for loose coupling with a plurality of remote modules 12 to induce electrical voltages in the remote sensors to induce electrical voltages in the remote sensors; or (5) other similar schemes for remotely generating electromagnetic energy.

External source 14 of electromagnetic energy 13 may also include a non-controlled source(s) of electromagnetic energy such as electromagnetic energy generated by natural and non-natural phenomena and are not controlled by system 10. Also, external source of electromagnetic energy 13 may include a combination of the sources described above.

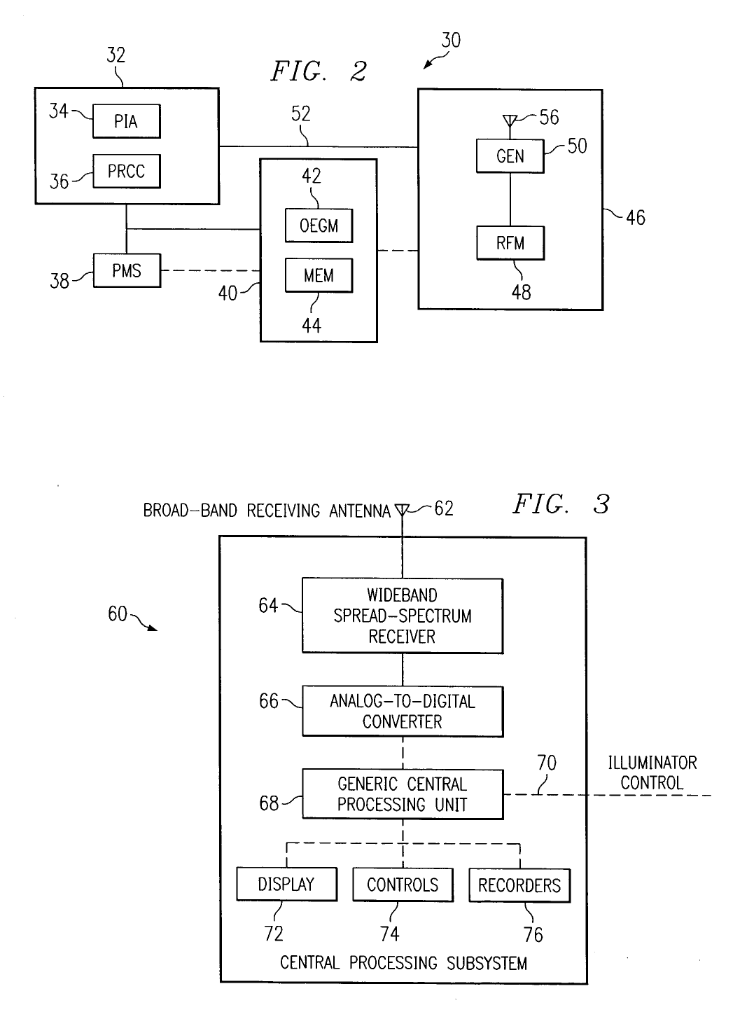

Each remote sensing module 12 is operable to: (1) sense an environmental parameter such as temperature, pressure, voltage, current, strain, and other measures of energy; (2) convert the sensed parameter to a uniquely recognizable signal; and (3) transmit the signal by means of wideband, encoded, spread spectrum energy to the central processing subsystem. Remote sensing modules 12 will be described later in more detail, with regard to FIG. 2.

Central processing subsystem 16 receives multiple signals from simultaneously operating remote sensing modules, and de-convolve the encoded signals into individual data streams, control the electromagnetic illuminator powering the remote sensing modules, and displays and records the data streams. Central processing subsystem 16 may provide feedback 18 to the electromagnetic illuminator based on information associated with the decoded signal. Central processing subsystem 16 will be described later in more detail, with regard to FIG. 3.

FIG. 2 illustrates a remote sensing module 30 for employing in system 10, in accordance with a particular embodiment of the present invention. Module 30 includes a power accumulator 32 operable to receive incident electromagnetic energy generated by external source 14. Additionally, accumulator 32 is operable to convert the incident electromagnetic energy to a source of power for remote module 30.

In accordance with a particular embodiment of the present invention, power accumulator 32 comprises a power interception aperture 34 and a power rectifier, conditioner and controller 36. If electromagnetic illumination power interception is used, power interception aperture 34 may comprise a miniature cavity-backed spiral antenna to receive radio waves. The size of the antenna can be designed to be comparable with the wavelength of the incident radio waves to increase the efficiency of interception. The RF frequencies are therefore compatible with the small size of the antenna to produce efficient interception of the incident electromagnetic field. For high-energy photonic interception, power interception aperture 34 may comprise a photo-galvanic converter (e.g. solar cell) to receive high-energy photons. Also, power interception aperture 34 may comprise a multi-turn transformer with secondary winding to receive magnetic fields.

Power rectifier, conditioner, and controller 36 may comprise an analog-design electrical integrated circuit that is operable to (1) rectify the electrical alternating current output from power interception aperture 34, (2) condition the rectified power to make it suitable for use by both digital and analog components, (3) control the power to promote efficient use, and (4) forward control signals encoded in incident electromagnetic energy. Also, power rectifier, conditioner, and controller 36 may include voltage boosters or multipliers to assist converting incident electromagnetic energy into a suitable power supply for components of remote sensing module 30.

Power lines 52 couple accumulator 32 to a parameter measurement sensor 38, an encoder 40, and a transmitter 46. Power lines 52 provide a source of power for these components, which may transfer outputs necessary to power both digital and analog components. After which, parameter measurement sensor 38 is operable to measure a value of at least one environmental parameter adjacent remote module 30. As discussed above, the at least one environmental parameter contemplates parameters such as temperature, pressure, voltage, current, strain, acoustic waves, vibration, moisture, and other measures of environmental parameters.

Parameter measurement sensor 38 is operable to convert environmental characteristics into electrical signals. For example, an integrated circuit for a digital multi-vibrator (e.g. astable flip-flop) may comprise a mechanical membrane above an electrical ground plane to produce a capacitive element in remote module 30. Atmospheric changes may produce changes in the separation of the membrane from the ground plane, resulting in a change in capacitance. The capacitive change changes the operating frequency of the multi-vibrator and the frequency change can be considered an encoded signal for atmospheric change. Other physical effects on electrical circuits might be used to encode signals with values of environmental characteristics, e.g. resistive changes with temperature or mechanical strain, voltages induced by mechanical shock, etc. Other example devices may include micro electromechanical devices, piezoelectric devices, etc.

Upon measuring the value of the at least one environmental parameter, encoder 40 encodes a signal with the value of the at least one environmental parameter. Additionally, encoder 40 is operable to encode the signal with a unique identification associated with remote module 30. In one embodiment of the invention, encoder 40 comprises an orthogonal encoder generator and modulator 42 and a module ID code memory 44. Orthogonal encoder generator and modulator 42 uses the output of parameter measurement sensor 38 as the modulating signal imposed on a unique digital sequence. The unique digital sequence of a respective module may be one out of a set of N unique sequences, wherein N represent the number of modules. Additionally, each unique sequence has an identifiable and decodable power spectrum. Therefore, all members of the set may exist simultaneously as signals in some environment and still be separable into their original identity (as long as the environment does not cause nonlinear interaction of the individual power spectra—RF signals in free space satisfy such a condition). The length of the pseudo-random digital sequence determines the number, N, of unique members in the set. Such encoding schemes can support a low clock rate, which can reduce power dissipation, because each module has 100% of the transmitting time available rather than 1/N (e.g. 0.1% for 1,000 modules) as in the case of time interleaved transmissions. Generation of the individual members of the set may require a “key”.

Module ID code memory 44 stores the unique digital sequence used by orthogonal encoder generator and modulator 42, and thereby controls the specific pseudo-random transmission sequences. The specific design specification of a given remote module may dictate which type of memory is selected to store the unique sequence. For example, Read Only Memory (ROM) is established during the production of an integrated circuit (IC) and generally cannot be changed but it consumes no power when inactive. As another example, Random Access Memory (RAM) generally provides greater speed then ROM but RAM consumes power for data retention.

After the signal is encoded, transmitter 46 transmits the signal to central processing subsystem 16. In one embodiment of the particular invention, transmitter 46 comprises an RF modulator 48, a wideband RF power generator 50, and a broadband transmitting antenna 56. RF Modulator 48 conditions and converts a binary digital sequence for use as a modulation signal. Wideband RF power generator 50 generates the signal detected by central processing subsystem 16. While the wideband RF power generator 50 may comprise common analog designs for RF circuits, a change in transistor threshold design voltage may improve efficiency at low supply voltages. Additionally, wideband RF power generator 50 realizes a greater power efficiency than a narrowband generator because wideband RF power generator 50 is not required to produce a precision, stable frequency.

Broadband transmitting antenna 56 radiates the signal generated by wideband RF power generator 50 into the external environment for reception by central processing subsystem 16. In one embodiment of the present invention, broadband transmitting antenna 56 is integrated into the same area of a chip as power interception aperture 34 and combining elements reduces the area required. Also, broadband transmitting antenna 56 and power interception aperture 34 may operate in a similar spectra or separate spectra. Additionally, broadband characteristics, as compared to narrowband characteristics, help to preclude significant interaction between incident electromagnetic energy and signals being transmitted.

Remote sensing module 30 of FIG. 2 includes a miniature size that draws on solid state integrated circuit processes for fabricating extremely small analog and digital electrical circuitry as well as microelectromechanical systems (MEMS). While remote sensing module 30 may be integrated on a single chip, it is not so limited. The power interception aperture draws energy from an illumination field and is compatible with the small size of the remote sensing module. A modification of the transistors typically used in integrated circuits is incorporated that allows operation at very low threshold voltages to simplify the design of the internal power controller and reduce power consumption.

The use of the encoding techniques generate a unique spectral power “fingerprint” that makes each module's transmissions discernable from every other module's fingerprint (up to a number associated with the code length used). A broadband transmitting antenna is integrated into the same physical space as the power interception aperture.

FIG. 3 illustrates a central processing subsystem 60 for employing in system 10, in accordance with a particular embodiment of the present invention. In one embodiment of the present invention, central processing subsystem 60 includes a broadband receiving antenna 62 operable to receive broadband signals transmitted by remote modules and may have a coverage pattern that includes all of the remote modules. Broadband receiving antenna 62 is coupled to a wideband spread-spectrum receiver 64, which may have sufficient bandwidth to accommodate the module signals and provide linear gain to avoid inter-modulating the signals from individual modules. Wideband spread-spectrum receiver 64 is coupled to analog-to-digital converter 66. The analog-to-digital converter is operable to convert combined RF signals to analog signals. Upon conversion, central processing unit 68 resolves separate module signals and recovers encoded data carried by each signal. Additionally, central processing unit 68 may perform additional algorithms to format and analyze data collected by a plurality of sensors. For example, a pressure gradient may be mapped into a given area or volume by correlating data with the location of the respective modules. Also, central processing unit 68 may also control external source 14 by sending signals through a communication link 70. Central processing unit may provide or receive data from a display 72, controls 74, and/or a recorder 76.

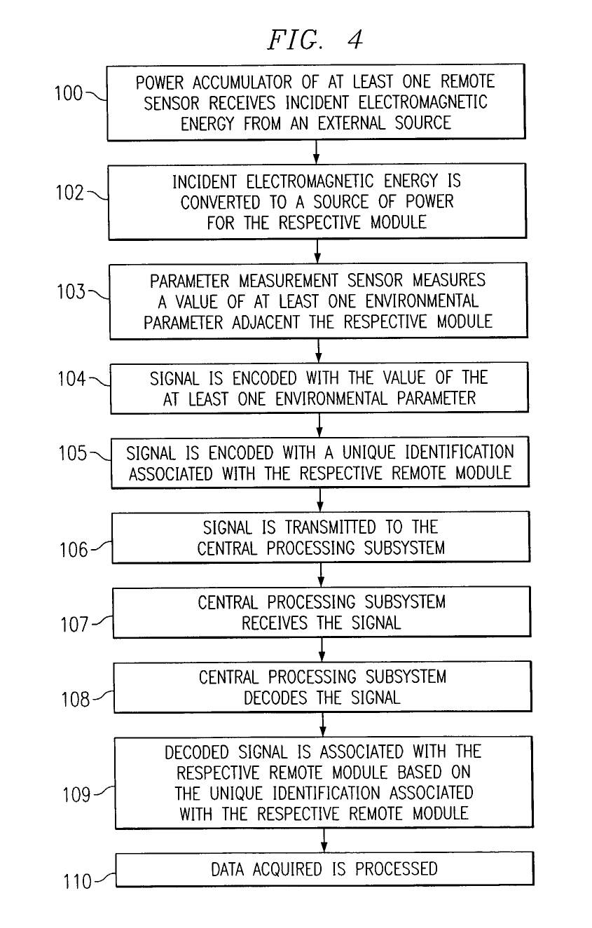

FIG. 4 illustrates an example method for remote sensing. The method begins at step 100, where a power accumulator of at least one remote module receives incident electromagnetic energy from an external source. At step 102, the incident electromagnetic energy is converted to a source of power for the respective remote module. At step 103, parameter measurement sensor 38 measures a value of at least one environmental parameter adjacent the respective remote module. At step 104, a signal is encoded with the value of the at least one environmental parameter and at step 105, the signal is encoded with a unique identification associated with the respective remote module. The signal is transmitted to central processing subsystem 16, at step 106. At step 107, central processing subsystem 16 receives the signal. At step 108, central processing subsystem 16 decodes the signal and at step 109, the decoded signal is associated with the respective remote module based on the unique identification associated with the respective remote module. At step 110, the data acquired is processed, at which point the method ends. System 10 may be used for small, electronics-based monitoring for test instrumentation and aircraft health monitoring. System 10 accommodates a high number of data samples collected from dispersed locations. Installation costs (connection and power) are low, and little to no maintenance is required. The system provides a low sensor production cost and provides a simple, user-friendly readout. The configuration of the system accommodates sensors that can operate at thousands, or tens of thousands slower clock rates, and power consumption is dropped dramatically. The power consumption can be reduced below 1 volt, to further reduce power consumption.

The design of the remote sensing modules can accommodate a number of transducer types and alternative power sources. Optical and acoustic energy are two examples of power sources. Piezoelectric, thermal and capacitive (pressure) transducers are examples under consideration for different sensor tasks.

Although the present invention has been described with several embodiments, a number of changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. A method for remote sensing, comprising:
receiving, at a first module of an array of modules, incident electromagnetic energy from an external source;
converting the incident electromagnetic energy to a source of power for the first module;
measuring, at the first module, a value of at least one environmental parameter adjacent the first module;
encoding a signal with the value of the at least one environmental parameter; and
transmitting the signal to a central processing subsystem independently of transmissions from other ones of the array of modules.

2. The method according to claim 1, further comprising:
encoding the signal with a unique identification associated with the first module.

3. The method of claim 2, further comprising:
decoding the signal at the central processing subsystem; and
associating the signal with the first module based on the unique identification associated with the first module.

4. The method of claim 2, wherein the external source is a narrow-spectrum radio frequency transmitter.

5. The method of claim 2, wherein the incident electromagnetic energy comprise radio waves.

6. The method of claim 5, wherein the radio waves are received at a miniature cavity-backed spiral antenna.

7. The method of claim 2, wherein converting the incident electromagnetic energy comprises rectifying the incident electromagnetic energy.

8. The method of claim 2, wherein the at least one environmental parameter comprises atmospheric pressure.

9. The method of claim 2, wherein a microelectromechanical device is used to measure the at least one environmental parameter.

10. The method of claim 2, wherein encoding the signal comprises imposing the signal on a unique digital sequence stored in Read Only Memory.

11. The method of claim 2, further comprising:
receiving, at the central processing subsystem, a plurality of signals from the array of modules, each of the signals being associated with a respective one of the modules.

12. The method of claim 11, wherein the plurality of signals each include a unique identification associated with the respective module.

13. The method of claim 12, further comprising:
decoding the plurality of signals at the central processing subsystem; and
associating each signal of the plurality of signals with the respective module based on the unique identification associated with the respective module.

14. The method of claim 13, wherein the central processing subsystem provides feedback to the external source.

15. The method of claim 13, wherein the central processing subsystem performs additional algorithms to format and analyze the plurality of signals.

16. A remote module, comprising:
a power accumulator operable to receive incident electromagnetic energy from an external source;
a converter coupled to the power accumulator and operable to convert the incident electromagnetic energy to a source of power for the remote module;
a parameter measurement sensor coupled to the converter and operable to measure, at the remote module, a value of at least one environmental parameter adjacent the remote module;
an encoder coupled to the power converter and the parameter measurement sensor and operable to encode a signal with the value of the at least one environmental parameter; and
a transmitter operable to transmit the signal to a central processing subsystem independently of transmissions from other ones in an array of modules.

17. A remote module according to claim 16, wherein the encoder is further operable to encode the signal with a unique identification associated with the remote module.

18. A system for remote sensing, comprising:
a plurality of remote modules, each remote module comprising:
a power accumulator operable to receive incident electromagnetic energy from an external source;
a converter coupled to the power accumulator and operable to convert the incident electromagnetic energy to a source of power for the remote module;
a parameter measurement sensor coupled to the converter and operable to measure, at the remote module, a value of at least one environmental parameter adjacent the remote module;
an encoder coupled to the power converter and the parameter measurement sensor and operable to encode a signal with the value of the at least one environmental parameter; and
a transmitter operable to transmit the signal to a central processing subsystem independently of transmissions from other ones of the plurality of modules; and
a central processing subsystem operable to receive at least one signal from at least one remote module.

19. The system of claim 18, wherein the encoder of each remote module of the plurality of modules is further operable to encode the signal associated with the respective module; and to encode each signal with a unique identification associated with the respective module.

20. The system of claim 19, wherein the central processing subsystem is further operable to decode a plurality of signals at the central processing subsystem; and to associate each signal of the plurality of signals with the respective module based on the unique identification associated with the respective module.
